(19) United States
(12) Patent Application Publication
(10) Pub. No.: US 2024/0087086 A1
(43) Pub. Date: Mar. 14, 2024

(54) IMAGE PROCESSING METHOD, IMAGE PROCESSING APPARATUS, PROGRAM, TRAINED MACHINE LEARNING MODEL PRODUCTION METHOD, PROCESSING APPARATUS, AND IMAGE PROCESSING SYSTEM

(71) Applicant: CANON KABUSHIKI KAISHA, Tokyo (JP)

(72) Inventors: NORIHITO HIASA, Tochigi (JP); YOSHINORI KIMURA, Tochigi (JP); YUICHI KUSUMI, Tochigi (JP)

(21) Appl. No.: 18/518,041

(22) Filed: Nov. 22, 2023

Related U.S. Application Data
(63) Continuation of application No. PCT/JP2022/020572, filed on May 17, 2022.

(30) Foreign Application Priority Data
May 26, 2021 (JP) 2021-088597

(51) Int. Cl. G06T 3/40; G06T 5/00; G06T 5/50; G06T 7/00; H04N 25/615

(52) U.S. Cl. CPC G06T 3/4053; G06T 3/4015; G06T 5/002; G06T 5/003; G06T 5/50; G06T 7/0002; H04N 25/615; G06T 2207/20081; G06T 2207/30168

(57) ABSTRACT

An image processing method includes obtaining a captured image by image capturing using an optical apparatus, and obtaining resolution performance information about a resolution performance of the optical apparatus, and generating an output image by reducing a sampling pitch of the captured image based on the captured image and the resolution performance information, wherein the information indicating the resolution performance is a map, and each pixel of the map indicates the resolution performance of a corresponding pixel of the captured image.

### CROSS-REFERENCE TO RELATED APPLICATIONS

This application is a Continuation of International Patent Application No. PCT/JP2022/020572, filed May 17, 2022, which claims the benefit of Japanese Patent Application No. 2021-088597, filed May 26, 2021, both of which are hereby incorporated by reference herein in their entirety.

### BACKGROUND OF THE INVENTION

### Field of the Invention

The present invention relates to image processing for reducing a sampling pitch of a captured image.

### Background Art

United States Patent Application Publication No. 2018/0075581 discusses a method for enlarging a low-resolution image to an image having the same number of pixels as the number of pixels of a high-resolution image by a bicubic interpolation and inputting the enlarged image to a trained machine learning model, to thereby generate a high-resolution enlarged image. The use of the trained machine learning model for image enlargement processing makes it possible to achieve image enlargement processing with higher accuracy than general methods such as a bicubic interpolation.

### CITATION LIST

### Patent Literature

PTL 1: United States Patent Application Publication No. 2018/0075581

However, the method discussed in United States Patent Application Publication No. 2018/0075581 poses a problem that an artifact that does not actually exist may appear in the enlarged image, or Moire patterns that are present in the low-resolution image may remain in the enlarged image. This problem also occurs in other image enlargement methods (bicubic interpolation, sparse coding, etc.) that do not use a machine learning model. This problem occurs not only in image enlargement processing, but also in other processing for reducing a sampling pitch of an image (e.g., demosaicing).

### SUMMARY OF THE INVENTION

Accordingly, the present invention is directed to improving the accuracy of processing for reducing a sampling pitch of a captured image.

According to an aspect of the present invention, an image processing method includes obtaining a captured image by image capturing using an optical apparatus, and obtaining resolution performance information about a resolution performance of the optical apparatus, and generating an output image by reducing a sampling pitch of the captured image based on the captured image and the resolution performance information, wherein the information indicating the resolution performance is a map, and each pixel of the map indicates the resolution performance of a corresponding pixel of the captured image.

Further features of the present invention will become apparent from the following description of exemplary embodiments with reference to the attached drawings.

### BRIEF DESCRIPTION OF THE DRAWINGS

FIG. 1A is a graph illustrating a relationship between a modulation transfer function and a Nyquist frequency according to first and second exemplary embodiments.

FIG. 1B is a graph illustrating a relationship between a modulation transfer function and a Nyquist frequency according to first and second exemplary embodiments.

FIG. 2 is a block diagram illustrating an image processing system according to the first exemplary embodiment.

FIG. 3 is an external view of the image processing system according to the first exemplary embodiment.

FIG. 4 is a flowchart illustrating machine learning model training processing according to the first exemplary embodiment.

FIG. 5 is a flowchart illustrating enlarged image generation processing according to the first exemplary embodiment.

FIG. 6A illustrates a configuration of a machine learning model according to the first and second exemplary embodiments.

FIG. 6B illustrates a configuration of a machine learning model according to the first and second exemplary embodiments.

FIG. 7 is a flowchart illustrating enlarged image generation processing according to the first exemplary embodiment.

FIG. 8 is a block diagram illustrating an image processing system according to the second exemplary embodiment.

FIG. 9 is an external view of the image processing system according to the second exemplary embodiment.

FIG. 10 is a flowchart illustrating machine learning model training processing according to the second exemplary embodiment.

FIG. 11A illustrates a color filter array according to the second exemplary embodiment.

FIG. 11B illustrates a Nyquist frequency according to the second exemplary embodiment.

FIG. 12 illustrates a demosaic image generation processing flow according to the second exemplary embodiment.

FIG. 13 is a flowchart illustrating demosaic image generation processing according to the second exemplary embodiment.

### DESCRIPTION OF THE EMBODIMENTS

Exemplary embodiments of the present invention will be described in detail below with reference to the drawings. In the drawings, the same members are denoted by the same reference numerals, and redundant descriptions thereof are omitted.

Prior to detailed description of exemplary embodiments, an outline of the present invention will be briefly described. According to the present invention, processing for reducing a sampling pitch of a captured image (hereinafter referred to as “upsampling”) uses resolution performance information that is information about a resolution performance of an optical apparatus used for obtaining a captured image. This leads to an improvement in the accuracy of upsampling. To explain the reason for this, a problem to be solved by upsampling and the generation principle thereof will be described in detail below.

In a case where an image sensor converts an object image formed by an optical system into a captured image, sampling is performed by pixels of the image sensor. Accordingly, frequency components that exceed the Nyquist frequency of the image sensor among the frequency components forming the object image are mixed with low-frequency components due to aliasing, so that Moire patterns are generated. In upsampling of the captured image, the Nyquist frequency increases as the sampling pitch decreases. Therefore, it may be desirable to generate an ideal image in which aliasing does not occur until the increased Nyquist frequency is reached. However, it is generally difficult to perform image processing by distinguishing whether a structure included in the captured image including Moire patterns corresponds to the Moire patterns or the structure of an object.

In general upsampling as typified by a bilinear interpolation, Moire patterns remain even after the captured image is upsampled. On the other hand, in upsampling using a machine learning model, high-frequency components before aliasing occurs can be estimated to some extent, and thus it can be expected that the Moire patterns can be partially removed. However, since it is difficult to distinguish Moire patterns from the structure of an object as described above, even when a machine learning model is used, a part of the Moire patterns can be erroneously recognized as an object and can remain, so that a part of the object can be erroneously recognized as Moire patterns and an artifact can be generated.

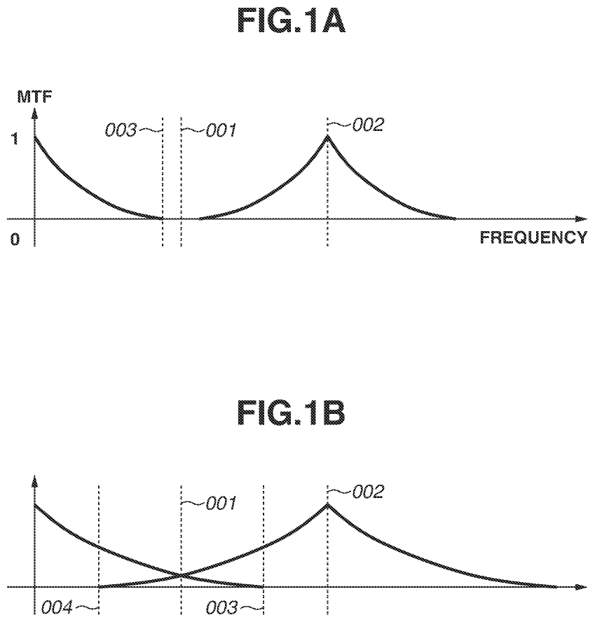

Accordingly, in the present invention, upsampling of a captured image uses resolution performance information about an optical apparatus used to obtain the captured image. This will be described in more detail with reference to FIGS. 1A and 1B. FIGS. 1A and 1B illustrate frequency characteristics of a modulation transfer function (MTF) representing the resolution performance of an optical apparatus. A horizontal axis represents a spatial frequency in a certain direction, and a vertical axis represents the MTF. FIG. 1A illustrates a state where a cutoff frequency 003 (in this specification, the cutoff frequency refers to the frequency at which the MTF is 0 at frequencies above the cutoff frequency of the optical apparatus is less than or equal to a Nyquist frequency 001. In this case, Moire patterns are not present in the captured image. Even when the MTF is set at a cycle of a sampling frequency 002, there are no areas where the MTFs overlap each other. Accordingly, if the resolution performance corresponds to that illustrated in FIG. 1A, the resolution performance information is applied (input) to an algorithm, thereby enabling the algorithm to determine that there is no need to estimate high-frequency components before Moire patterns are generated based on the structure of Moire patterns. This makes it possible to prevent an artifact from being generated in the image processing result.

FIG. 1B illustrates a state where the cutoff frequency 003 exceeds the Nyquist frequency 001. Also, in this case, information about this state is applied to the algorithm, thereby enabling the algorithm to identify a frequency band in which Moire patterns may be generated due to aliasing. In the example of FIG. 1B, there is a possibility that Moire patterns may be generated in a frequency band between a frequency 004 obtained by subtracting the cutoff frequency 003 from the sampling frequency 002 and the Nyquist frequency 001, and Moire patterns are not generated in the other frequency bands. Thus, the application of the resolution performance information to the algorithm makes it possible to prevent an artifact from being generated. This leads to an improvement in the accuracy of upsampling of the captured image.

### First Exemplary Embodiment

An image processing system according to a first exemplary embodiment of the present invention will be described. In the first exemplary embodiment, image enlargement (upscaling) processing is performed as upsampling. However, the first exemplary embodiment can also be applied to other upsampling methods such as demosaicing. The image enlargement processing includes increasing sampling points on the entire captured image, and increasing sampling points on a partial area of the captured image (e.g., enlargement or digital zooming of a trimmed image). In the first exemplary embodiment, a machine learning model is used for image enlargement. However, the first exemplary embodiment can also be applied to other methods such as sparse coding.

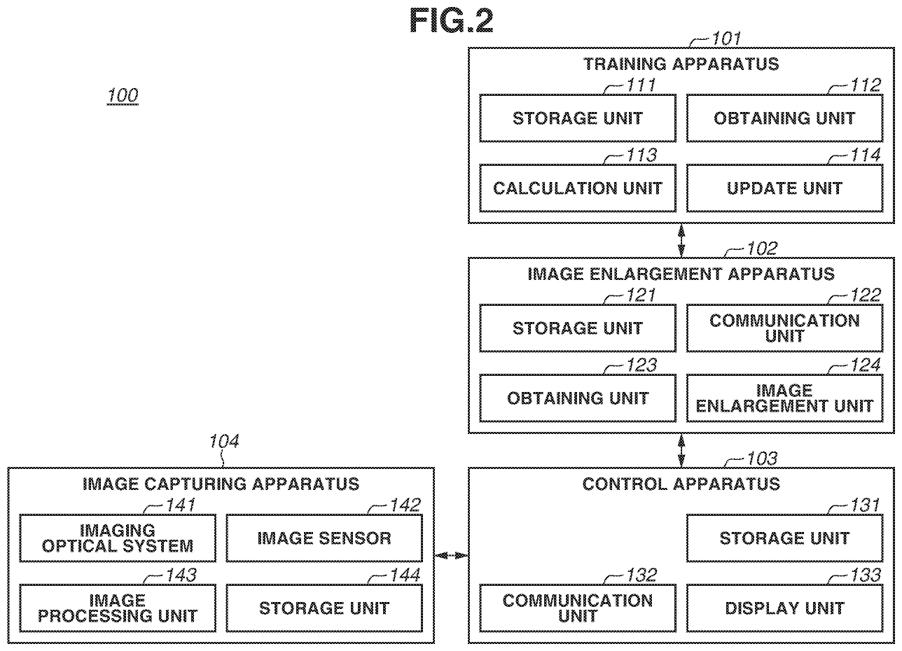

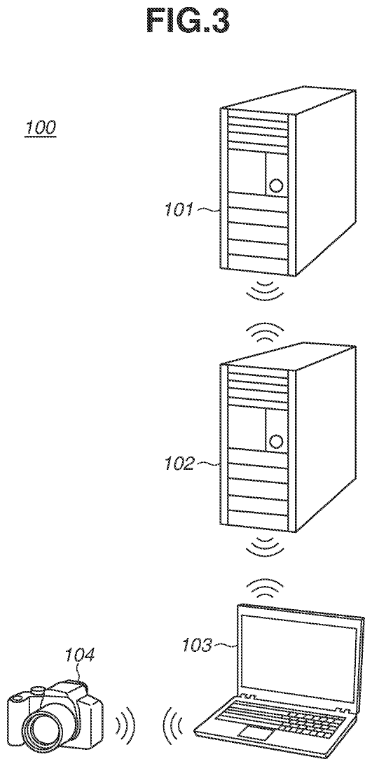

FIG. 2 is a block diagram illustrating an image processing system 100, and FIG. 3 is an external view of the image processing system 100. The image processing system 100 includes a training apparatus 101, an image enlargement apparatus 102, a control apparatus 103, and an image capturing apparatus 104, which are interconnected via a wired or wireless network. The control apparatus 103 includes a storage unit 131, a communication unit 132, and a display unit 133. The control apparatus 103 obtains a captured image from the image capturing apparatus 104 according to an instruction from a user, and transmits the captured image and a request for executing image enlargement processing to the image enlargement apparatus 102 via the communication unit 132.

The image capturing apparatus 104 includes an imaging optical system 141, an image sensor 142, an image processing unit 143, and a storage unit 144. The imaging optical system 141 forms an object image based on light from an object space, and the image sensor 142 having a configuration in which a plurality of pixels is arranged converts the formed image into the captured image. In this case, aliasing occurs in frequency components higher than the Nyquist frequency of the image sensor 142 among the frequency components of an object image. As a result, Moire patterns can be generated in the captured image. The image processing unit 143 executes predetermined processing (pixel defect correction, development, etc.), as needed, on the captured image. The captured image or the captured image on which processing has been performed by the image processing unit 143 is stored in the storage unit 144.

The control apparatus 103 obtains the captured image via communication or a storage medium. The entire captured image may be obtained, or only a part (partial area) of the captured image may be obtained.

The image enlargement apparatus 102 includes a storage unit 121, a communication unit (obtaining means) 122, an obtaining unit 123, and an image enlargement unit (generation means) 124. The image enlargement apparatus 102 generates an enlarged image (output image) by enlarging the captured image using a trained machine learning model. In this case, resolution performance information that is information about the resolution performance of an optical apparatus (imaging optical system 141 etc.) used to obtain the captured image. This processing will be described in detail below. The image enlargement apparatus 102 obtains information about the weights of the trained machine learning model from the training apparatus 101, and stores the obtained information in the storage unit 121.

The training apparatus 101 includes a storage unit 111, an obtaining unit 112, a calculation unit 113, and an update unit 114, and preliminarily trains a machine learning model using a data set. Information about the weights of the machine learning model generated by training is stored in the storage unit 111.

When the enlarged image is generated by the image enlargement apparatus 102, the control apparatus 103 obtains the enlarged image from the image enlargement apparatus 102 and presents the enlarged image to the user via the display unit 133.

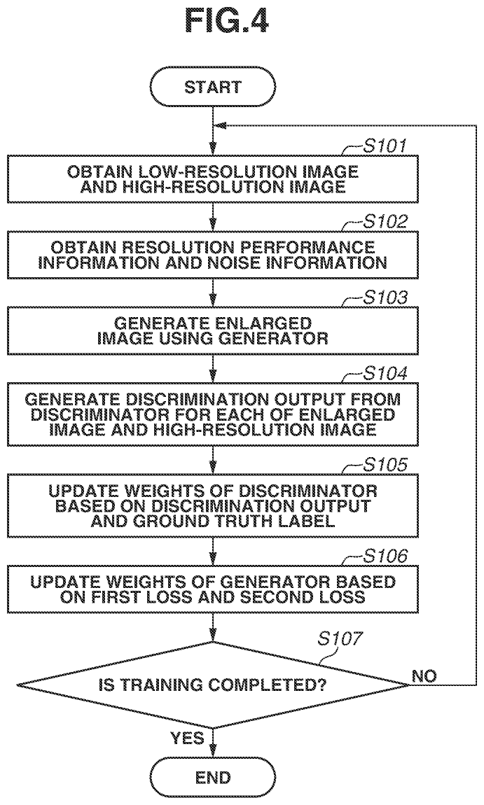

A method (method for producing a trained machine learning model) for training (determining weights) a machine learning model to be executed by the training apparatus 101 will now be described with reference to a flowchart illustrated in FIG. 4. In the first exemplary embodiment, machine learning model training processing is performed using a generative adversarial network (GAN). However, the present invention is not limited to this processing. Examples of the machine learning model include a neural network, genetic programming, and a Bayesian network. Examples of the neural network include a convolutional neural network (CNN), a GAN, and a recurrent neural network (RNN).

Each step in FIG. 4 is executed by the training apparatus 101.

In step S101, the obtaining unit 112 obtains one or more pairs of a high-resolution image and a low-resolution image from the storage unit 111. The storage unit 111 stores a data set including a plurality of high-resolution images and a plurality of low-resolution images. In other words, as described in detail below, the obtaining unit 112 functions as data obtaining means that obtains a first image (low-resolution image) and a second image (high-resolution image) with a smaller sampling pitch than the sampling pitch of the first image.

The low-resolution image is an image to be input to a machine learning model (generator in the first exemplary embodiment) during training of the machine learning model, and has a relatively small number of pixels (image with a large sampling pitch). The accuracy of the trained machine learning model increases as the properties of the captured image to be actually enlarged using the trained machine learning model can be reproduced in the low-resolution image with higher accuracy. Examples of the properties of the captured image include a resolution performance, color representation, and noise characteristics. For example, in a case where the captured image is represented by red, green, and blue (RGB) whereas the low-resolution image is represented by monochrome or YUV, the color representation in the captured image does not match the color representation in the low-resolution image, which may lead to deterioration in the accuracy of a task (accuracy of upsampling). Although the important properties of the captured image vary depending on the type of a task using a machine learning model, information about the frequency band in which Moire patterns are generated is important as described above in the task of image enlargement, and thus the resolution performance is particularly important. Therefore, the resolution performance of the captured image to be actually enlarged (resolution performance of the optical apparatus used to obtain the captured image to be actually enlarged) using the trained machine learning model may desirably fall within the range of resolution performances of a plurality of low-resolution images used for training.

The high-resolution image is a ground truth image used in training of the machine learning model. The high-resolution image is an image obtained by capturing the same scene as that of the corresponding low-resolution image, and the sampling pitch of the high-resolution image is smaller (that is, has a larger number of pixels) than the sampling pitch of the low-resolution image. In the first exemplary embodiment, the sampling pitch of the high-resolution image is one-half of the sampling pitch of the low-resolution image. Therefore, the machine learning model quadruples the number of pixels of the input image (twice vertically and horizontally). However, the present invention is not limited to this configuration. The plurality of low-resolution images and the plurality of high-resolution images may desirably include various objects (edges, texture, gradation, flat portion, and the like with different orientations and intensities) so that the machine learning model can deal with captured images of various objects. At least a part of the high-resolution image includes frequency components higher than or equal to the Nyquist frequency of the low-resolution image.

In the first exemplary embodiment, the high-resolution image and the low-resolution image that are generated by an image capturing simulation based on an original image are used. However, the present invention is not limited to this example. The high-resolution image and the low-resolution image may be generated using an image obtained by an image capturing simulation using three-dimensional data on an object space, instead of using an original image. Alternatively, the high-resolution image and the low-resolution image may be generated by an actual image capturing process using image sensors having different pixel pitches.

The original image is an undeveloped raw image (image having a linear relationship between a light intensity and a signal value), and has a sampling pitch that is less than or equal to the sampling pitch of the high-resolution image. At least a part of the original image includes frequency components higher than or equal to the Nyquist frequency of the low-resolution image. The low-resolution image is generated by reproducing the same image capturing process as that for the captured image to be actually enlarged using the trained machine learning model using the original image as an object. Specifically, blur due to aberration or diffraction caused in the imaging optical system 141 and blur due to an optical low-pass filter of the image sensor 142, a pixel opening, and the like are applied to the original image. If various types of optical apparatuses in various states are used to obtain the captured image to be enlarged using the trained machine learning model and different types of blur can act on the captured image depending on the optical apparatuses, the data set may desirably include the low-resolution images to which different types of blur are applied. The blur can vary depending on the position of each pixel of the image sensor 142 (image height and azimuth with respect to an optical axis of the imaging optical system 141). In addition, if the imaging optical system 141 can take various states (e.g., a focal length, an F-number, and a focus distance), the blur can vary depending on the state of the imaging optical system 141. If the image capturing apparatus 104 is a lens-interchangeable camera and different types of optical systems can be used as the imaging optical system 141, the blur also varies depending on the type of each optical system. The blur varies also when various types of image capturing apparatuses 104 are used and different pixel pitches and different optical low-pass filters are used.

The blur to be applied to the original image may be blur caused by the imaging optical system 141 and the image sensor 142, or blur obtained by approximating the blur. For example, a point spread function (PSF) for blur caused by the imaging optical system 141 and the image sensor 142 may be approximated by a two-dimensional Gauss distribution function, a mixture of a plurality of two-dimensional Gauss distribution functions, Zernike polynomials, or the like. More alternatively, an optical transfer function (OTF) or MTF may be approximated by a two-dimensional Gauss distribution function, a mixture of a plurality of two-dimensional Gauss distribution functions, Legendre polynomials, or the like. In this case, the blur may be applied to the original image using the approximated PSF, OTF, MTF, or the like.

After the blur is applied to the original image, downsampling is performed at a sampling pitch of the image sensor 142. The image sensor 142 has a configuration in which RGB color filters are arranged in a Bayer array. Accordingly, it may be desirable to perform sampling on the low-resolution image to match the Bayer array. However, the present invention is not limited to this configuration. The image sensor 142 may have a configuration of a monochrome type, honeycomb array, three plate type, or the like. If various types of image sensors 142 are used to obtain the captured image to be enlarged using the trained machine learning model and the pixel pitch of the captured image can vary, the low-resolution image may be generated for a plurality of sampling pitches to cover the varying range. In the first exemplary embodiment, noise generated in the image sensor 142 is also applied to the low-resolution image. This is because, if noise is not applied to the low-resolution image (noise is not taken into consideration in training of a machine learning model), there is a possibility that not only an object but also noise can be regarded as the structure of the object and can be emphasized in captured image enlargement processing. If the intensity of noise generated in the captured image varies (e.g., a plurality of International Organization for Standardization (ISO) sensitivities can be set during image capturing), a plurality of low-resolution images obtained by changing the intensity of noise within a range in which noise can be generated may be desirably included in the data set.

The high-resolution image is generated such that blur due to the pixel opening corresponding to one-half of the pixel pitch of the low-resolution image is applied to the original image and downsampling is performed at a sampling pitch that is one-half of the sampling pitch of the low-resolution image, to thereby arrange pixels in a Bayer array. If the sampling pitch of the original image is equal to the sampling pitch of the high-resolution image, the original image may be directly used as the high-resolution image. In the first exemplary embodiment, blur due to aberration and diffraction of the imaging optical system 141 and blur due to the optical low-pass filter of the image sensor 142 are not applied during generation of the high-resolution image. As a result, the machine learning model is trained so that the above-described blur correction processing can be performed along with image enlargement processing. However, the present invention is not limited to this example. Blur to be applied to the low-resolution image may also be applied to the high-resolution image, or blur obtained by reducing the blur applied to the low-resolution image may be applied to the high-resolution image. In the first exemplary embodiment, noise is not applied during generation of the high-resolution image. Thus, the machine learning model is trained so as to execute denoising along with image enlargement processing. However, the present invention is not limited to this example. Noise having an intensity that is about the same as the intensity of noise applied to the low-resolution image, or noise having an intensity different from the intensity of noise applied to the low-resolution image may be applied. In the case of applying noise to the high-resolution image, it may be desirable to apply noise having a correlation with noise in the low-resolution image (e.g., noise generated by the same random number as that of noise applied to the low-resolution image). This is because, if noise in the high-resolution image has no correlation with noise in the low-resolution image, training using a plurality of images in the data set may result in averaging the effects of noise in the high-resolution image, so that a desired effect cannot be obtained in some cases.

In the first exemplary embodiment, image enlargement processing is executed on the developed captured image. Accordingly, it may be desirable to use developed images as the low-resolution image and the high-resolution image. Therefore, development processing similar to that for the captured image is executed on the low-resolution image and the high-resolution image in a Bayer state, and the low-resolution image and the high-resolution image are stored in the data set. However, the present invention is not limited to this example. Raw images may be used as the low-resolution image and the high-resolution image, and the captured image may be enlarged in the raw state. If compression noise due to Joint Photographic Experts Group (JPEG) coding or the like is generated in the captured image, similar compression noise may be applied to the low-resolution image. This enables the machine learning model to be trained to execute compression noise removal processing along with image enlargement processing.

In step S102, the obtaining unit 112 obtains resolution performance information and noise information. In other words, the obtaining unit 112 also functions as data obtaining means that obtains the resolution performance information.

The resolution performance information is information about the resolution performance depending on blur applied to the low-resolution image. If the resolution performance is low (MTF is 0 or a sufficiently small value at a frequency lower than or equal to the Nyquist frequency of the low-resolution image), Moire patterns are not present in the low-resolution image. On the other hand, if the resolution performance is high (MTF has a value at a frequency higher than or equal to the Nyquist frequency), Moire patterns are not present in frequency bands other than the frequency band in which aliasing occurs. Accordingly, information about the frequency band in which Moire patterns are generated in the low-resolution image can be obtained from the resolution performance information. Therefore, the resolution performance information may include information based on the degree of blur applied to the low-resolution image. The resolution performance information may also include information based on a spread of the PSF or the MTF for blur. A phase transfer function (PTF) for blur by itself does not correspond to the resolution performance information. This is because the PTF merely represents a deviation of an imaging position.

In the first exemplary embodiment, the resolution performance information used during captured image enlargement processing is information about blur in which all effects, such as the aberration and diffraction of the imaging optical system 141, the optical low-pass filter of the image sensor 142, and the pixel opening, are integrated. However, the present invention is not limited to this example. The resolution performance may be represented only by a part of blur (e.g., blur occurring in the imaging optical system 141). For example, if the optical low-pass filter and the pixel pitch are fixed and are not changed, the resolution performance may be represented only by blur occurring in the imaging optical system 141. However, in this case, it may be desirable to determine the resolution performance so as to match the resolution performance of the low-resolution image. The resolution performance information may be determined for blur obtained by excluding the effects of the optical low-pass filter and the pixel opening from the blur applied to the low-resolution image.

The noise information is information about noise applied to the low-resolution image. The noise information includes information indicating the intensity of noise. The intensity of noise can be represented by a standard deviation of noise, the ISO sensitivity of the image sensor 142 corresponding to the standard deviation of noise, or the like. If denoising is executed on the captured image before enlargement processing, denoising may also be executed on the low-resolution image to obtain parameters (indicating the intensity and the like) for executed denoising as noise information. Information about the intensity of noise and information about denoising may be used in combination as noise information. Even if the noise or denoising is varied due to this information, highly accurate image enlargement processing can be achieved, while adverse effects can be prevented.

Specific examples of resolution performance information and noise information will be described below. In the first exemplary embodiment, the resolution performance information is generated by the following method. However, the present invention is not limited to this method.

The resolution performance information according to the first exemplary embodiment is a map in which the number of pixels (size) two-dimensionally arranged (horizontally and vertically) is the same as the number of pixels in the low-resolution image. Each pixel in the map indicates the resolution performance in the corresponding pixel of the low-resolution image. In other words, the resolution performance information according to the first exemplary embodiment is information that varies depending on the position of the low-resolution image. The map includes a plurality of channels. A first channel indicates the resolution performance in a horizontal direction, and a second channel indicates the resolution performance in a vertical direction. Specifically, the resolution performance information according to the first exemplary embodiment is information including a plurality of channel components representing different resolution performance components for the same pixel of the low-resolution image.

The resolution performance is a value based on a frequency at which the MTF for white color in the blur applied to the low-resolution image has a default value (predetermined value) in the applicable direction. The “frequency at which the MTF has the default value” will be described in more detail. That is, the frequency is a minimum frequency among the frequencies at which the MTF is less than or equal to a threshold (0.5 in the first exemplary embodiment, but the threshold is not limited to 0.5). The resolution performance is represented by a value obtained by standardizing the above-described minimum frequency with the sampling frequency of the low-resolution image. The sampling frequency used for standardization is the reciprocal of the pixel pitch that is common to RGB. In other words, the resolution performance information according to the first exemplary embodiment is information obtained using information about the pixel pitch corresponding to the low-resolution image. However, the value representing the resolution performance is not limited to this value. The resolution performance for each of RGB may be represented by six channels, instead of using the MTF for white color, and different frequencies for RGB may also be used in standardization.

Other examples of the resolution performance information will be described below. The direction of the resolution performance indicated by the resolution performance information may include a meridional (moving radius) direction and a sagittal (azimuth) direction. Further, a third channel representing the azimuth of each pixel may be added. Not only the resolution performance in two directions, but also the resolution performance in a plurality of directions may be represented by increasing the number of channels. On the other hand, the resolution performance may be represented by only one channel in a specific direction, or by averaging the resolution performances in all directions. Not only a map, but also a scalar value or a vector may be used as the resolution performance information. For example, if the imaging optical system 141 is a super-telephoto lens or has a large F-number, variations in the resolution performance due to the image height and azimuth are extremely small. Accordingly, as in the case described above, the advantageous effects of the invention can be fully obtained using a scalar value instead of using a map indicating the performance for each pixel. As the resolution performance, an integral value of the MTF or the like may be used instead of the value based on the frequency at which the MTF has the default value.

The resolution performance may also be represented by a spread of the PSF. The resolution performance may also be represented by a half-value width of the PSF in a plurality of directions, or a spatial range in which the intensity of the PSF has a value greater than or equal to a threshold. Also, in this case, if the resolution performance is represented by a scalar value instead of using a map, the resolution performance may be represented by a channel in a specific direction, or by averaging the resolution performances in all directions, in the same manner as described above for the MTF.

The resolution performance may be represented by a coefficient obtained by fitting the MTF or PSF. For example, the MTF or PSF may be fitted by power series, Fourier series, Gaussian mixture model Legendre polynomials, Zernike polynomials, or the like, and each coefficient for fitting may be presented by a plurality of channels.

Further, the resolution performance information may be generated by calculation based on the blur applied to the low-resolution image, or the resolution performance information corresponding to a plurality of types of blur may be preliminarily stored in the storage unit 111 and may be obtained from the storage unit 111.

Like the resolution performance information, noise information indicates a map in which the number of pixels two-dimensionally arranged is the same as the number of pixels in the low-resolution image. In the present exemplary embodiment, the first channel is a parameter representing the intensity of noise before denoising the low-resolution image, and the second channel is a parameter representing the intensity of executed denoising. If compression noise is present in the low-resolution image, the intensity of the compression noise may be added as a channel. Like the resolution performance information, noise information may be in the form of a scalar value or a vector.

Steps S102 and S101 may be executed in reverse order or simultaneously.

In step S103, the calculation unit 113 generates an enlarged image using a generator, which is a machine learning model, based on the low-resolution image, the resolution performance information, and the noise information. The enlarged image is an image obtained by reducing the sampling pitch of the low-resolution image. In other words, the calculation unit 113 functions as calculation means that generates the enlarged image obtained by reducing the sampling pitch of the low-resolution image using a machine learning model based on the low-resolution image and the resolution performance information.

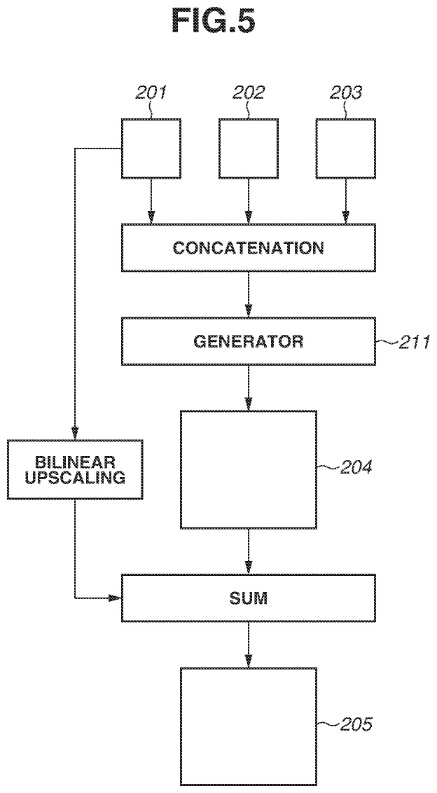

Enlarged image generation processing will be described with reference to FIG. 5. In FIG. 5, “sum” represents the sum of elements (pixels), and “concatenation” represents concatenation of information in a channel direction. As described above, in the first exemplary embodiment, resolution performance information 202 and noise information 203 indicate maps in which the number of pixels two-dimensionally arranged is the same as the number of pixels in a low-resolution image 201. The low-resolution image 201, the resolution performance information 202, and the noise information 203 are concatenated in a channel direction and are input to a generator 211 as input data, thereby generating a residual component 204. In the residual component 204, the number of pixels two-dimensionally arranged is the same as the number of pixels in the high-resolution image. The low-resolution image 201 is enlarged to an image having the same number of pixels as the number of pixels in the high-resolution image by a bilinear interpolation or the like, and the enlarged image is added to the residual component 204, thereby generating an enlarged image 205. Specifically, in the first exemplary embodiment, the enlarged image 205 is generated by adding a first intermediate image obtained by reducing the sampling pitch of the low-resolution image without using the resolution performance information to a second intermediate image (residual component 204) generated using the low-resolution image and the resolution performance information. The second intermediate image is an image with a smaller sampling pitch than the sampling pitch of the low-resolution image.

The enlarged image 205 may be directly generated by the generator 211 without involving the residual component 204. In a case where information, such as a scalar value or a vector, in which the number of pixels two-dimensionally arranged does not match the number of pixels in the low-resolution image 201 is used as the resolution performance information 202 and the noise information 203, the resolution performance information 202 and the noise information 203 may be converted into a feature map via a convolution layer. In this case, the resolution performance information 202 and the noise information 203 that are converted into the feature map and the low-resolution image 201 (or a feature map obtained by converting the low-resolution image 201) may be concatenated in a channel direction. In a case where the resolution performance information 202 and the noise information 203 (or information obtained by converting these pieces of information into a feature map) are concatenated in a channel direction after the low-resolution image 201 is converted into the feature map, the number of pixels in the feature map of the low-resolution image 201 does not necessarily match the number of pixels in the low-resolution image 201. In this case, the number of pixels two-dimensionally arranged in the resolution performance information 202 and the noise information 203 (or information representing these pieces of information as a feature map) may be set to be equal to the number of pixels two-dimensionally arranged in the feature map obtained by converting the low-resolution image 201.

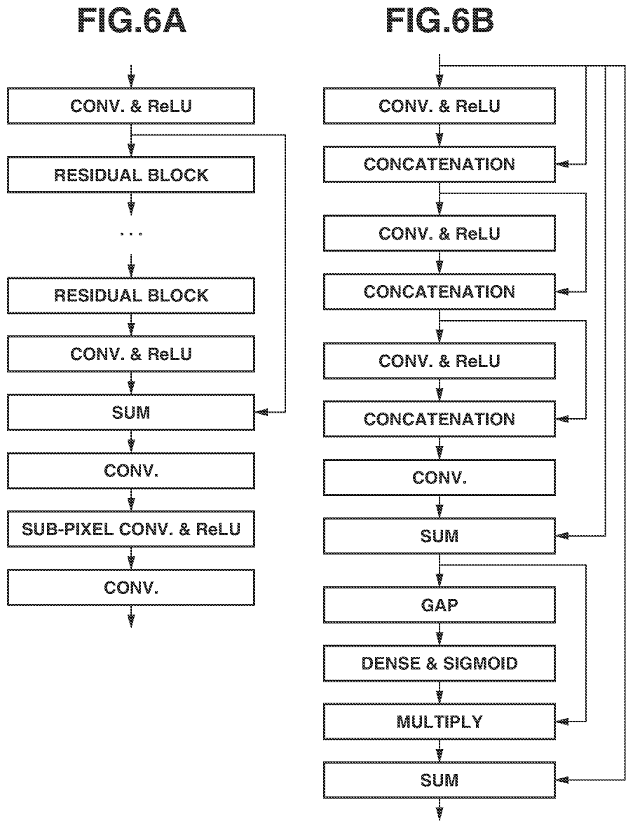

The generator 211 according to the present exemplary embodiment is a CNN having a configuration illustrated in FIG. 6A. However, the present invention is not limited to this configuration.

In FIG. 6A, “cony.” represents a convolution, “ReLU” represents a Rectified Linear Unit, and “sub-pixel cony.” represents a sub-pixel convolution. An initial value for the weights of the generator 211 may be generated using a random number or the like.

In the first exemplary embodiment, the number of pixels two-dimensionally arranged in the residual component 204 is set to be equal to the number of pixels in the high-resolution image by quadrupling the number of input pixels two-dimensionally arranged by sub-pixel convolution.

In FIG. 6A, “residual block” represents residual blocks. Each residual block includes a plurality of linear combination layers and an activation function, and is configured to take the sum of an input and an output of each block. FIG. 6B illustrates residual blocks according to the first exemplary embodiment. In the first exemplary embodiment, the generator 211 includes 16 residual blocks. However, the number of residual blocks is not limited to 16. To enhance the performance of the generator 211, the number of residual blocks may be increased.

In FIG. 6B, “GAP” represents global average pooling, “dense” represents a fully-connected layer, “sigmoid” represents a sigmoid function, and “multiply” represents the product for each element. An attention map is generated using the GAP and dense layer, thereby improving the accuracy of a task.

The low-resolution image 201 may be preliminarily enlarged by a bilinear interpolation or the like so that the number of pixels in the low-resolution image 201 matches the number of pixels in the high-resolution image, and the enlarged image may be input to the generator 211. This eliminates the need for the generator 211 to perform sub-pixel convolution. However, as the number of pixels two-dimensionally arranged in the low-resolution image 201 increases, the number of times of taking the linear combination increases, which leads to an increase in calculation load. Accordingly, it may be desirable to input the image to the generator 211 without enlarging the low-resolution image 201, unlike in the first exemplary embodiment, and to enlarge the low-resolution image 201 in the generator 211.

In step S104 illustrated in FIG. 4, the calculation unit 113 inputs each of the enlarged image 205 and the high-resolution image to a discriminator, and generates a discrimination output. The discriminator discriminates whether the input image is an image generated by the generator 211 (enlarged image 205 in which high-frequency components are estimated from the low-resolution image) or an actual high-resolution image (image in which frequency components higher than or equal to the Nyquist frequency of the low-resolution image is obtained during image capturing). A CNN or the like may be desirably used as the discriminator. The initial value for the weights of the discriminator is determined by a random number or the like. As the high-resolution image to be input to the discriminator, any actual high-resolution image may be input. There is no need to input the image corresponding to the low-resolution image 201.

In step S105, the update unit 114 updates the weights of the discriminator so that an accurate discrimination output can be generated based on a discrimination output and a ground truth label. In the first exemplary embodiment, assume that the ground truth label for the enlarged image 205 indicates “0”, and the ground truth label for the actual high-resolution image indicates “1”. Sigmoid cross-entropy is used as a loss function, but any other function may be used instead. To update the weights, backpropagation is used.

In step S106, the update unit 114 updates the weights of the generator 211 based on a first loss and a second loss. The first loss is a loss based on the difference between the enlarged image 205 and the high-resolution image corresponding to the low-resolution image 201. In the first exemplary embodiment, a mean square error (MSE) is used, but instead a mean absolute error (MAE) or the like may also be used. The second loss is a sigmoid cross-entropy between a discrimination output and a ground truth label 1 when the enlarged image 205 is input to the discriminator. The generator 211 is trained to cause the discriminator to erroneously determine the enlarged image 205 to be an actual high-resolution image. Accordingly, the ground truth label 1 (corresponding to the actual high-resolution image) is set. Steps S105 and S106 may be executed in reverse order. In other words, the update unit 114 functions as update means that updates the weights of the machine learning model using the enlarged image and the high-resolution image.

In step S107, the update unit 114 determines whether training of the generator 211 is completed. If it is determined that training of the generator 211 is not completed (NO in step S107), the processing returns to step S101 to obtain one or more new pairs of the low-resolution image 201 and the high-resolution image. If it is determined that training of the generator 211 is completed (YES in step S107), information about the weights of the trained machine learning model produced in this processing flow is stored in the storage unit 111. Only the generator 211 is used during the actual image enlargement processing. Accordingly, the weights of only the generator 211 may be stored without storing the weights of the discriminator.

Before training of the GAN using the discriminator, the generator 211 may be trained using only the first loss. Further, a first data set and a second data set may be stored in the storage unit 111. Then, training in steps S101 to S107 may be carried out using the first data set, and training in steps S101 to S107 may be carried out using the second data set with the weights as an initial value. The first data set includes a smaller number of high-resolution images including high-frequency components higher than or equal to the Nyquist frequency of the low-resolution image (that is, Moire patterns are less likely to be generated in the low-resolution image) than in the second data set. Accordingly, Moire patterns are more likely to remain in the generator 211 trained with the first data set, while an artifact is less likely to appear. On the other hand, in the generator 211 trained with the second data set, Moire patterns can be removed, but an artifact is more likely to appear. By storing the weights of the generator 211 obtained at intervals during training using the second data set, it becomes possible to select a weight that achieves balanced removal of Moire patterns and appearance of the artifact in a subsequent process.

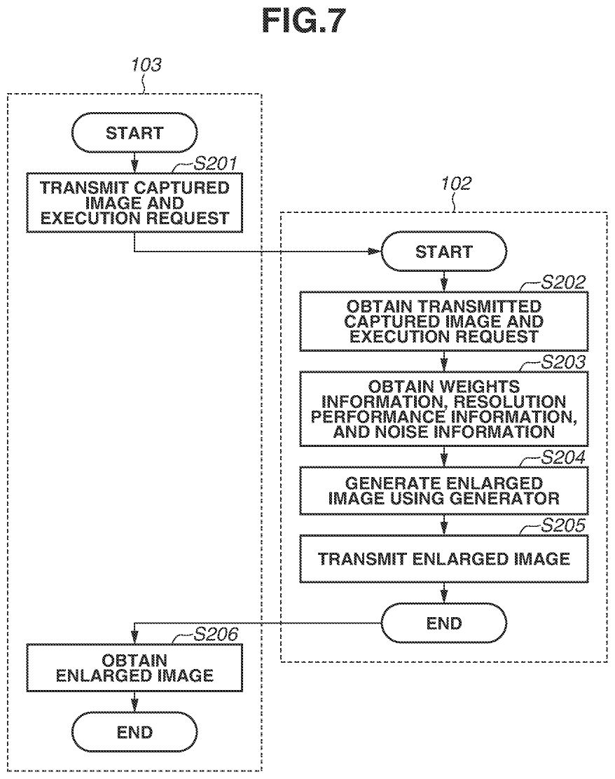

Next, captured image enlargement processing will be described with reference to a flowchart illustrated in FIG. 7. Each step is executed by the image enlargement apparatus 102 or the control apparatus 103.

In step S201, the communication unit 132 of the control apparatus 103 transmits the captured image and a request for executing enlargement processing on the captured image to the image enlargement apparatus 102. In other words, the communication unit 132 functions as transmission means that transmits a request for causing the image enlargement apparatus 102 to execute processing on the captured image. However, if the image enlargement apparatus 102 can obtain the captured image from an apparatus other than the control apparatus 103, the control apparatus 103 need not necessarily transmit the captured image to the image enlargement apparatus 102. The captured image is a developed image, like the image used in training.

In step S202, the communication unit 122 of the image enlargement apparatus 102 obtains the captured image transmitted from the control apparatus 103 and a request for executing enlargement processing on the captured image. In other words, the communication unit 122 functions as reception means that receives the request from the control apparatus 103. The communication unit 122 functions as obtaining means for obtaining the captured image.

In step S203, the obtaining unit 123 obtains generator weights information, resolution performance information, noise information from the storage unit 121. In other words, the obtaining unit 123 functions as obtaining means that obtains resolution performance information. The resolution performance information is information indicating the resolution performance of an optical apparatus used to obtain the captured image. The optical apparatus according to the first exemplary embodiment includes the imaging optical system 141, the optical low-pass filter of the image sensor 142, and a pixel opening. To obtain the resolution performance information and the noise information, the image enlargement apparatus 102 obtains necessary information from meta information about the captured image. Examples of necessary information include the type of the imaging optical system 141, the state during image capturing of the imaging optical system 141 (focal length, F-number, focus distance, etc.), the pixel pitch of the image sensor 142, the optical low-pass filter, and the ISO sensitivity (noise intensity) during image capturing. In addition, information indicating whether to denoise the captured image, a denoise parameter, a trimming position (position of the optical axis of the imaging optical system 141 with respect to the trimmed captured image), and the like may also be obtained. The image enlargement apparatus 102 generates the resolution performance information (two-channel map in the first exemplary embodiment) based on the obtained information and a data table indicating the resolution performance of the imaging optical system 141 stored in the storage unit 121. The storage unit 121 stores information about the type, state, and image height of the imaging optical system 141 and the resolution performance corresponding to azimuth sampling points as a data table. Based on the data table, the resolution performance information corresponding to the captured image can be generated by an interpolation or the like. The resolution performance information according to the first exemplary embodiment is similar to that used in training, and includes a value indicating the resolution performance in the horizontal direction in the first channel of each pixel and the resolution performance in the vertical direction in the second channel of each pixel in the map in which the number of pixels two-dimensionally arranged is the same as the number of pixels in the captured image. As the value representing the resolution performance, a value obtained by standardizing the minimum frequency at which the MTF in the applicable direction is less than the threshold (0.5) with the sampling frequency (reciprocal of pixel pitch) of the image sensor 142. Like the MTF used in training, the MTF for white color in the blur obtained by combining the effects of the imaging optical system 141, the optical low-pass filter of the image sensor 142, and the pixel opening is used. If the resolution performance of the captured image does not change (the type and state of the imaging optical system 141 and the image sensor 142 are fixed), the resolution performance information in a map state may be stored in the storage unit 121 and may be called. The noise information is a map in which the number of pixels two-dimensionally arranged is the same as the number of pixels in the captured image. The first channel indicates the intensity of noise that is generated during image capturing, and the second channel indicates a denoise parameter for denoising executed on the captured image.

In step S204, the image enlargement unit 124 generates an enlarged image using the generator illustrated in FIG. 5 based on the captured image, the resolution performance information, and the noise information. The enlarged image is an image with a sampling pitch that is one-half of the sampling pitch of the captured image (the number of pixels is quadrupled). In other words, the image enlargement unit 124 functions as generation means that generates an output image obtained by reducing the sampling pitch of the captured image.

In step S205, the communication unit 122 transmits the enlarged image to the control apparatus 103. After that, the processing of the image enlargement apparatus 102 is terminated.

In step S206, the communication unit 132 of the control apparatus 103 obtains the enlarged image, and then the processing of the control apparatus 103 is terminated. The obtained enlarged image is stored in the storage unit 131, or is displayed on the display unit 133. Alternatively, the obtained enlarged image may be stored in another storage device connected via a wired or wireless connection from the control apparatus 103 or the image enlargement apparatus 102.

The first exemplary embodiment uses a machine learning model for image enlargement processing, but instead may use other methods. For example, in the case of sparse coding, the low-resolution image in which Moire patterns are not generated and the high-resolution image corresponding to the low-resolution image are used to generate a first dictionary set. Further, a second dictionary set is generated using the low-resolution image in which Moire patterns are generated and the high-resolution image corresponding to the low-resolution image. Image enlargement processing may be carried out using the first dictionary set on an area where Moire patterns are not generated based on the resolution performance information about the captured image, and image enlargement processing may be carried out using the second dictionary set on the other areas. While the first exemplary embodiment uses one captured image, the present invention is not limited to this example. The enlarged image may be generated based on a plurality of captured images obtained by shifting sub-pixels and resolution performance information.

With the above-described configuration, it is possible to provide the image processing system 100 capable of improving the accuracy of upsampling of the captured image.

### Second Exemplary Embodiment

An image processing system according to a second exemplary embodiment of the present invention will be described. In the second exemplary embodiment, demosaicing is performed as upsampling. The second exemplary embodiment can also be applied to any other upsampling processing. The second exemplary embodiment uses a machine learning model for demosaicing, but also can be applied to any other method.

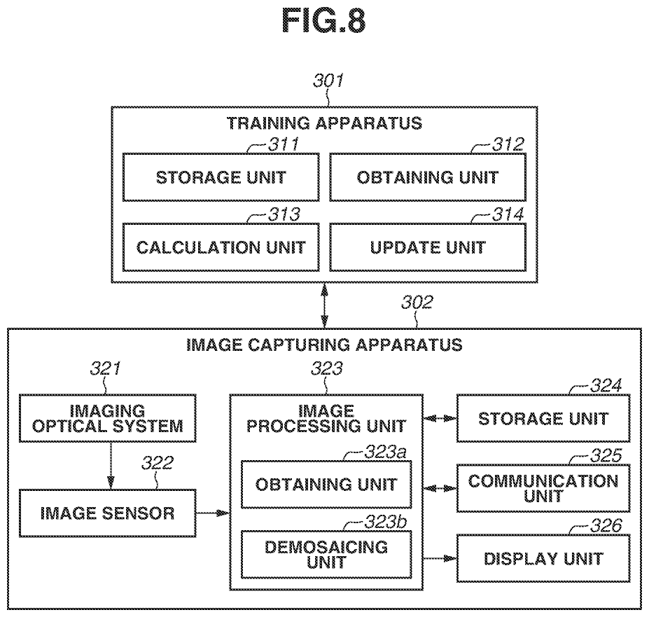

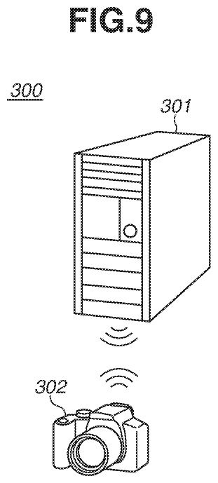

FIG. 8 is a block diagram illustrating an image processing system 300, and FIG. 9 is an external view of the image processing system 300. The image processing system 300 includes a training apparatus 301 and an image capturing apparatus 302. The image capturing apparatus 302 includes an imaging optical system 321, an image sensor 322, an image processing unit 323, a storage unit 324, a communication unit 325, and a display unit 326. The imaging optical system 321 forms an object image based on light from an object space, and the image sensor 322 generates a captured image by capturing an object image. The captured image is an image in which RGB pixels are arranged in a Bayer array. The captured image is obtained in a live view of an object space before image capturing, or when a release button is pressed by the user. The image processing unit 323 executes development processing on the captured image. Then, the captured image is stored in the storage unit 324, or is displayed on the display unit 326. During development processing on the captured image, demosaicing using a machine learning model is executed to thereby generate a demosaic image (output image). The machine learning model is preliminarily trained by the training apparatus 301, and information about the weights of the trained machine learning model is obtained via the communication unit 325. However, the weights of the machine learning model trained by the training apparatus 301 may be preliminarily (e.g., before shipment) stored in the storage unit 324 of the image capturing apparatus 302. In demosaicing of the captured image, the resolution performance information about the resolution performance of the imaging optical system 321 is used. This processing will be described in detail below.

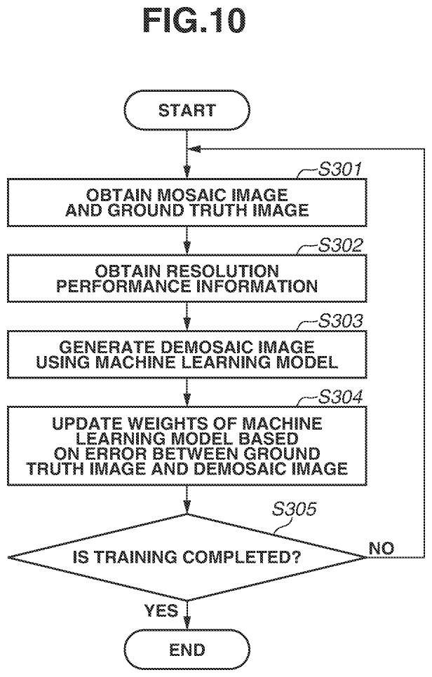

First, training of the machine learning model will be described with reference to a flowchart illustrated in FIG. 10. Each step is executed by the training apparatus 301.

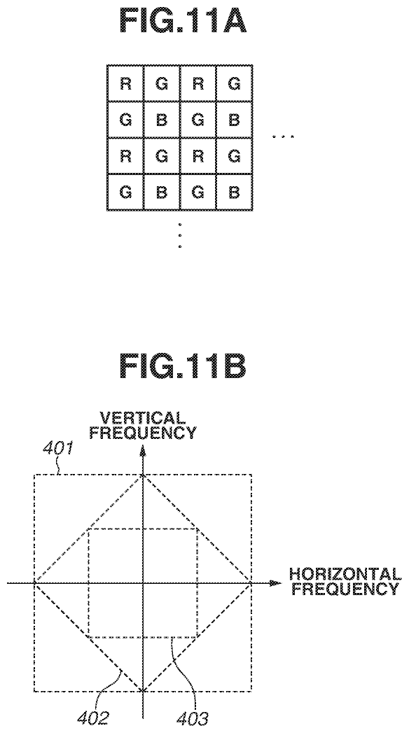

In step S301, the obtaining unit 312 obtains one or more pairs of a mosaic image and a ground truth image from the storage unit 311. The mosaic image is an RGB Bayer image that is the same as the captured image. FIG. 11A illustrates a Bayer array, and FIG. 11B illustrates a Nyquist frequency of each color in the Bayer array. G represents a sampling pitch that is a square root of 2 of the pixel pitch in a diagonal direction, and includes a Nyquist frequency 402. R and B represent sampling pitches that are twice the pixel pitch in the horizontal and vertical directions, and include a Nyquist frequency 403. The ground truth image is an image including a number of two-dimensionally arranged pixels corresponding to the number of pixels in the mosaic image, and includes three RGB channels. The ground truth image includes a sampling pitch that is equal to the pixel pitch for each of RGB, and all colors include a Nyquist frequency 401. The ground truth image is generated as an original image using an image captured by a computer graphics (CG) or three plate type image sensor. Alternatively, an image including RGB signal values in each pixel may be generated by reducing the captured image in a Bayer array, and the image may be used as the original image. At least a part of the original image includes frequency components higher than or equal to the Nyquist frequencies 402 and 403 in each color of the Bayer array. The ground truth image is generated by applying blur due to aberration and diffraction occurring in the imaging optical system 321, or blur due to the optical low-pass filter of the image sensor 322, the pixel opening, or the like to the original image. The mosaic image is generated by sampling the ground truth image in a Bayer array. A plurality of mosaic images to which different types of blur are applied and the ground truth image are generated, so that blur in the actual captured image falls within the blur range. The mosaic image is not limited to a Bayer array.

In step S302, the calculation unit 313 obtains resolution performance information. In the second exemplary embodiment, resolution performance information is generated for each of RGB. Like in the first exemplary embodiment, a value obtained by standardizing the minimum frequency at which the MTF is less than or equal to the threshold in the horizontal direction and the vertical direction in each of RGB with the Nyquist frequency for each of RGB is set as the resolution performance.

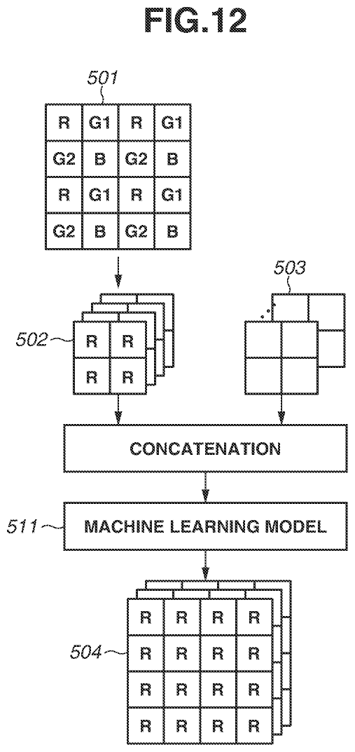

In step S303, the calculation unit 313 generates a demosaic image by inputting the mosaic image and the resolution performance information to a machine learning model. In the second exemplary embodiment, the demosaic image is generated in a processing flow as illustrated in FIG. 12. An RGGB image 502 is generated by rearranging a mosaic image 501 into four channels of R, G1, G2, and B. The RGGB image 502 and resolution performance information 503 that is a map with 8 (4×2) channels indicating the resolution performance of each pixel in the RGGB colors are concatenated in a channel direction, and are input to a machine learning model 511 to thereby generate a demosaic image 504. The machine learning model 511 has a configuration similar to that illustrated in FIGS. 6A and 6B. However, the present invention is not limited to this configuration. Alternatively, the mosaic image 501 in the Bayer array may be directly input to the machine learning model, without being rearranged into four channels.

In step S304, the update unit 314 updates the weights of the machine learning model 511 based on an error between the ground truth image and the demosaic image 504.

In step S305, the update unit 314 determines whether training of the machine learning model 511 is completed. If it is determined that training of the machine learning model 511 is not completed (NO in step S305), the processing returns to step S301. If it is determined that training of the machine learning model 511 is completed (YES in step S305), the training processing is terminated and information about the weights is stored in the storage unit 311.

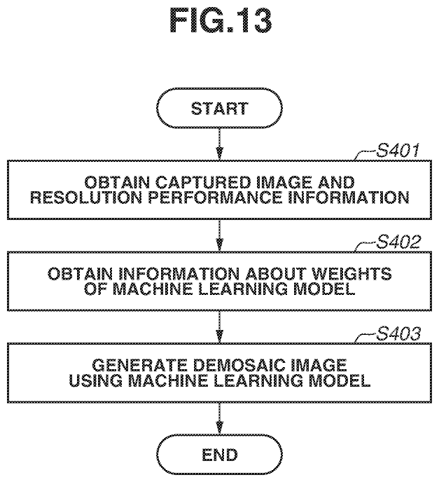

Next, demosaicing of the captured image will be described with reference to a flowchart illustrated in FIG. 13. Each step is executed by the image processing unit 323.

In step S401, an obtaining unit (obtaining means) 323a obtains the captured image and resolution performance information. The captured image is a Bayer array image, and the resolution performance information, such as the state or the like of the imaging optical system during image capturing, is obtained from the storage unit 324.

In step S402, the obtaining unit 323a obtains information about the weights of the machine learning model from the storage unit 324. Steps S401 and S402 may be executed in any order.

In step S403, a demosaicing unit (generation means) 323b generates a demosaic image based on the captured image and resolution performance information in the processing flow illustrated in FIG. 12. The demosaic image is an image obtained by demosaicing the captured image.

The image processing unit 323 may execute any other processing, such as denoising or gamma correction, as needed. Further, the image enlargement processing according to the first exemplary embodiment may also be carried out simultaneously with demosaicing.

With the above-described configuration, it is possible to provide the image processing system 300 capable of improving the accuracy of upsampling of the captured image.

### OTHER EXEMPLARY EMBODIMENTS

The present invention can also be implemented by processing in which a program for implementing one or more functions according to the above-described exemplary embodiments is supplied to a system or apparatus via a network or storage medium, and one or more processors in a computer of the system or apparatus read out and execute the program. The present invention can also be implemented by a circuit (e.g., an application-specific integrated circuit (ASIC)) for implementing one or more functions according to the exemplary embodiments.

According to the exemplary embodiments, it is possible to provide an image processing apparatus, an image capturing apparatus, an image processing method, an image processing program, and a storage medium, which are capable of improving the accuracy of upsampling of a captured image.

The present invention is not limited to the above embodiments and various changes and modifications can be made within the spirit and scope of the present invention. Therefore, to apprise the public of the scope of the present invention, the following claims are made.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, it is possible to improve the accuracy of processing for reducing a sampling pitch of a captured image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image processing method comprising:
obtaining a captured image by image capturing using an optical apparatus, and obtaining resolution performance information about a resolution performance of the optical apparatus; and
generating an output image by reducing a sampling pitch of the captured image based on the captured image and the resolution performance information,
wherein the information indicating the resolution performance is a map, and each pixel of the map indicates the resolution performance of a corresponding pixel of the captured image.

2. The image processing method according to claim 1, wherein the output image is an image obtained by enlarging or demosaicing the captured image.

3. The image processing method according to claim 1, wherein the resolution performance information includes information about a degree of blur occurring in the optical apparatus.

4. The image processing method according to claim 1, wherein the resolution performance information includes information based on at least one of a spread of a point spread function of the optical apparatus or a modulation transfer function of the optical apparatus.

5. The image processing method according to claim 1, wherein the resolution performance information includes different pieces of information for each pixel of the captured image.

6. The image processing method according to claim 1, wherein the resolution performance information is a map having a number of pixels corresponding to the number of pixels of the captured image.

7. The image processing method according to claim 6, wherein a value of each pixel of the map is based on a frequency at which a modulation transfer function of the optical apparatus has a predetermined value.

8. The image processing method according to claim 6, wherein the resolution performance information includes a plurality of channel components representing different resolution performance components for same pixel of the captured image.

9. The image processing method according to claim 1,
wherein the resolution performance information is obtained using information about at least one of a type of the optical apparatus or a state of the optical apparatus in the image capturing, and
wherein the state is at least one of a focal length, an F-number, or a focus distance.

10. The image processing method according to claim 1,
wherein the optical apparatus includes an image sensor, and
wherein the resolution performance information is obtained using information about a pixel pitch of the image sensor.

11. The image processing method according to claim 1, wherein the output image is obtained by correcting blur in the captured image due to the optical apparatus.

12. The image processing method according to claim 1, wherein in the generation of the output image, the output image is generated based on the captured image, the resolution performance information, and information about noise in the captured image.

13. The image processing method according to claim 12, wherein the information about the noise includes at least one of information about an intensity of noise generated in the image capturing, or information about denoising executed on the captured image.

14. The image processing method according to claim 1, wherein in the generation of the output image, the output image is generated by inputting the captured image and the resolution performance information to a machine learning model.

15. The image processing method according to claim 14, wherein in the generation of the output image, input data obtained by concatenating the captured image and the resolution performance information in a channel direction is input to the machine learning model.

16. The image processing method according to claim 14, wherein the machine learning model includes one or more residual blocks.

17. The image processing method according to claim 1, wherein in the generation of the output image, the output image is generated by adding a first intermediate image and a second intermediate image, the first intermediate image being obtained by reducing the sampling pitch of the captured image without using the resolution performance information, the second intermediate image being obtained by reducing the sampling pitch of the captured image using the captured image and the resolution performance information.

18. A storage medium storing a program for causing a computer to execute the image processing method according to claim 1.

19. An image processing apparatus comprising:
an obtaining unit configured to obtain a captured image by image capturing using an optical apparatus and to obtain resolution performance information about a resolution performance of the optical apparatus; and
a generation unit configured to generate an output image by reducing a sampling pitch of the captured image based on the captured image and the resolution performance information,
wherein the information indicating the resolution performance is a map, and each pixel of the map indicates the resolution performance of a corresponding pixel of the captured image

20. A method for producing a trained machine learning model comprising:
obtaining a first image, resolution performance information about a resolution performance corresponding to the first image, and a second image with a smaller sampling pitch than a sampling pitch of the first image;
generating an output image by inputting the first image and the resolution performance information to a machine learning model and reducing the sampling pitch of the first image; and
updating weights of the machine learning model using the output image and the second image,
wherein the information indicating the resolution performance is a map, and each pixel of the map indicates the resolution performance of a corresponding pixel of the captured image.

21. A processing apparatus comprising:
an obtaining unit configured to obtain a first image, resolution performance information about a resolution performance corresponding to the first image, and a second image with a smaller sampling pitch than a sampling pitch of the first image;
a calculation unit configured to generate an output image by inputting the first image and the resolution performance information to a machine learning model and reducing the sampling pitch of the first image; and
an update unit configured to update weights of the machine learning model using the output image and the second image,
wherein the information indicating the resolution performance is a map, and each pixel of the map indicates the resolution performance of a corresponding pixel of the captured image.

22. An image processing system comprising:
the image processing apparatus according to claim 19; and
a control apparatus configured to communicate with the image processing apparatus,
wherein the control apparatus includes a unit configured to transmit a request for executing processing on the captured image, and
wherein the image processing apparatus includes a unit configured to execute processing on the captured image in response to the request.
